(19) United States
(12) Patent Application Publication
(10) Pub. No.: US 2017/0335433 A1
(43) Pub. Date: Nov. 23, 2017

(54) RADIATION SHIELDING COMPOSITION AND METHOD OF MAKING THE SAME

(71) Applicants: 3M Innovative Properties Company, Saint Paul, MN (US); NATIONAL RESEARCH COUNCIL OF CANADA, Ottawa (CA)

(72) Inventors: Étienne Landry-Désy, Québec (CA); Fabrice Bernier, Ottawa (CA); Geneviéve Giasson, Saguenay (CA); Muhammad Z. Nawaz, Tustin, CA (US)

(21) Appl. No.: 15/525,400

(22) PCT Filed: Nov. 9, 2015
(86) PCT No.: PCT/US2015/059705

§ 371 Date: May 9, 2017

Related U.S. Application Data
(60) Provisional application No. 62/077,389, filed on Nov. 10, 2014.

(51) Int. Cl. C22C 1/05; G21F 1/06; C22C 29/06; C22C 29/14; G21F 1/08; B22F 1/02; B22F 3/18

(52) U.S. Cl. CPC C22C 1/051; G21F 1/08; G21F 1/06; B22F 1/025; C22C 29/062; C22C 29/14; B22F 2003/185

(57) ABSTRACT

Described herein is a radiation shielding composition and a method for making comprising: (i) a boron-containing powder wherein the boron-containing powder comprises at least a bimodal particle size distribution, and (ii) a metal, wherein the metal encapsulates the ceramic powder to form the radiation shielding composition.

### TECHNICAL FIELD

A radiation shielding composition and method of making is described, wherein the composition comprises at multimodal particle size distribution of boron-containing powder.

### SUMMARY

Radiation shielding materials are widely used in the nuclear industry. Among the applications, casks and racks are used to handle and store the fresh and spent nuclear fuel cells. The radiation shielding material is used in the cask in the form of panels having two main purposes: catching emitted neutrons responsible for the nuclear chain reaction, and dissipating heat generated by the nuclear reaction.

Metal matrix composite (MMC) materials, comprising a metal and a ceramic, increasingly have been used as radiation shielding materials in the nuclear industry for storage and transportation of fresh and spent fuel.

Two common manufacturing routes for MMC materials are observed in the industry: a liquid state process and powder metallurgy (a solid state process). In liquid state processes, various methods exist to enable homogeneous mixing particles of boron-containing materials with a molten metal composition. In powder metallurgy, particles of boron-containing material and metal particles are typically mixed in the powder state before being pressed, sintered, and/or hot formed.

Neutron absorber materials are critical components of the nuclear industry and contribute to public safety. Their manufacturing, certification and use are under strict government legislation. Licenses are granted to casks manufacturers for specific designs and material compositions.

Moreover, market tendency is to increase the stored fuel reactivity, requiring higher boron carbide concentration and increasing radiation shielding panel conductivity. Increasing the boron-containing fraction (typically a ceramic) concentration will however result in a decrease in density, which will reduce conductivity. Techniques must therefore be found to increase boron-containing content while maintaining optimum thermal conductivity and density.

Thus, there is a desire for neutron absorbing articles having increased final density and/or higher boron content, resulting in, in at least one embodiment, improved performance. There is also a need for improved processing and/or reducing manufacturing costs.

In one aspect, a radiation shielding composition is provided comprising:
(i) a boron-containing powder wherein the boron-containing powder comprises at least a bimodal particle size distribution, and
(ii) a metal, wherein the metal encapsulates the ceramic powder to form the radiation shielding composition.

In another aspect, a method of making a radiation shielding composition is provided comprising:
(a) providing (i) a boron-containing powder wherein the boron-containing powder comprises at least a bimodal particle size distribution, and (ii) a metal powder;
(b) mixing the metal powder and the boron-containing powder to prepare a mixed powder; and
(c) performing hot working on the mixed powder to obtain the radiation shielding composition.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term

“a”, “an”, and “the” are used interchangeably and mean one or more; and

“and/or” is used to indicate one or both stated cases may occur, for example A and/or B includes, (A and B) and (A or B).

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

In recent years, metal matrix composite (MMC) materials have been developed, not only for their strength and low density, but for other uses requiring a high Young's modulus, wear resistance, heat dissipation, corrosion resistance low thermal expansion, and neutron absorbing ability. In general, each function can be increased by increasing the amount of ceramics having the required function, but simply increasing the amounts can cause the workability, extrusion ability, rolling ability, ductility, and forging ability to be largely reduced.

Therefore, methods of pre-forming the ceramics, impregnating with a metal melt, then evenly dispersing high-concentration ceramics in the matrix phase have been contemplated, but this carries the drawback of possible defects occurring due to inadequate penetration of the melt and shrinkage forming during solidification. Further, agglomeration and segration of the ceramic in the metal is often present.

Powder metallurgy processes are commonly proposed as a solution to segregation problems if powders are homogeneously mixed. U.S. Pat. No. 7,725,520 discloses a powder metallurgy technique that provides homogeneous composition, but this process like many, requires several extensive processing steps that make it costly.

U.S. Pat. No. 7,998,401 (Okaniwa et al.) discloses an alternative method of increasing the ceramic content in an MMC, which is said to be easy to produce. Okaniwa et al. discloses electric pressure sintering of an aluminum/ceramic powder mix within a metal sheet and then subjecting this metal clad material to a plastic working step.

In the present disclosure, it has discovered that by using a boron-containing powder comprising a multimodial particle size distribution, high densities of powder can be achieved, resulting in, for example, a material comprising a boron-containing powder encapsulated in metal that has increased performance efficiency.

Metal Powder

A mixed powder comprising a metal powder and a ceramic powder is formed. The purpose of the metal component is to (a) mechanically bond the ceramic powder and (b) conduct heat through the radiation shielding composition. Typically the metal powder is aluminum, however other metal powders may be used including magnesium or stainless steel. Exemplary types of metal powders include pure aluminum (aluminum powder with purity of at least 99.0%, e.g., AA1100, AA1050, AA1070 etc.), or an aluminum alloy containing aluminum and 0.2 to 2% by mass of another metal. Such alloys include: Al—Cu alloys (AA2017 etc.), Al—Mg alloys (AA5052 etc.), Al—Mg—Si alloys (AA6061 etc.), Al—Zn—Mg alloys (AA7075 etc.) and Al—Mn alloys, either alone or as a mixture of two or more.

The composition of the metal powder to be selected can be determined in consideration of, for example, the desired properties, corrosion resistance, contamination control, deformation resistance in hot working, amount of boron-containing particles mixed, and raw material costs. For example, when wishing to increase the workability or heat dissipation, a pure aluminum powder (such as a series AA1XXX aluminum where X is a number) is preferable. A pure aluminum powder is also advantageous in terms of raw material costs as compared with the case of aluminum alloy powders. As the pure aluminum powder, it is preferable to use one with a purity of at least 99.0% by mass (commercially available pure aluminum powders usually have a purity of at least 99.7% by mass).

When wishing to further increase the resulting neutron absorbing ability, it may be preferable to add 1-50% by mass of one type of element providing neutron absorbing ability such as hafnium (Hf), samarium (Sm) or gadolinium (Gd) to the aluminum powder. Additionally, when high-temperature strength is required, it may be possible to add at least one element chosen from titanium (Ti), chrome (Cr), manganese (Mn), copper (Cu), nickel (Ni), molybdenum (Mo), niobium (nb), zirconium (Zr) and strontium (Sr), and when room-temperature strength is required, it may be possible to add at least one element chosen from silicon (Si), copper (Cu), magnesium (Mg) and zinc (Zn), at a proportion of 2% by mass or less for each element, and a total of 15% by mass or less.

In one embodiment of the present disclosure, the metal powder has a monomodal particle size distribution. In another embodiment of the present disclosure, the metal powder has a multimodal particle size distribution (e.g., bimodal, trimodal, etc.).

While the average particle size of the metal powder is not particularly restricted, the metal powder should generally be at most about 500 μm (micrometers), 150 μm, or even 60 μm. While the lower limit of the average particle size is not particularly limited as long as producible, the powder should generally be at least 1 μm, 5 μm, 10 μm, or even 20 μm. For the purposes of the present disclosure, the average particle size shall refer to the D₅₀ value measured by laser diffraction particle size distribution.

In one embodiment, at least bimodal particle size distribution for the metal powder comprises a D₅₀ of at least 1 μm, 3 μm, 5 μm, or even 10 μm and at most about, 60 μm, 40 μm, or even 20 μm. In one embodiment, the metal powder has a multimodal distribution, wherein the ratio of the average particle of a first mode (comprising the smaller particles) to a second mode (comprising the larger particles) is at least 1:2, 1:3, 1:5, 1:7, 1:11, or even 1:20.

The shape of the metal powder is also not limited, and may be any of teardrop-shaped, spherical, ellipsoid, flake-shaped or irregular.

The method of production of the metal powder may be produced by known methods of production of metallic powders. The method of production can, for example, be by atomization, melt-spinning, rotating disk, rotating electrode or other rapid-cooling solidification method, but an atomization method, particularly an inert gas atomization method, wherein a powder is produced by atomizing a melt is preferable for industrial production. These methods of production may impact the shape of the resulting particles, which may impact the packing efficiency of the powder.

Boron-Containing Powder

Among various elements used for radiation shielding, boron is the most popular due to its relative high abundance, low cost and high radiation absorption capability. Boron acts for controlling radiation by catching neutrons: there is a high probability that the ¹⁰B isotope, naturally present at about 20 atom %, will interact with a neutron passing by and will transform to ¹¹B isotope. Boron can also be enriched to higher ¹⁰B concentration, proportionally increasing the radiation shielding capability, but also significantly increasing cost. Boron is therefore found under various forms in the nuclear industry.

The boron-containing powder is mixed with the metal powder to eventually form the metal matrix composite. Exemplary boron-containing powders include for example, B₄C, TiB₂, B₂O₃, BN, FeB or FeB₂, used either alone or as a mixture. In one embodiment of the present disclosure, boron carbide (B₄C) is a preferred form of boron due to its high ionic stability and its high weight fraction of boron (>76.0% for nuclear grade boron carbide). Boron carbide is a hard and brittle ceramic.

The method of production of the boron-containing powder may be produced by known methods of production. After the systhesis of the boron-containing powder, a finishing process (such as jet milling or ball milling) may be used to adjust the particle size. These methods of production may impact the shape of the resulting particles, which may impact the packing efficiency of the powder. The shape of the powder may be any of spherical, ellipsoid, flake-shaped or irregular. A finishing process that leads to an ellipsoid-shaped particle or spherical-shaped particles is preferred.

In the present disclosure, the boron-containing powder has a multimodal particle size distribution (e.g., bimodal, trimodal, etc.).

While the average particle size of the boron-containing powder particles is not particularly restricted, in one embodiment, at least bimodal particle size distribution comprises a D₅₀ of at least 1 μm, 3 μm, 5 μm, or even 10 μm and at most about, 60 μm, 40 μm, or even 20 μm. If the average particle size is greater than 60 μm, coarse particles fragilize the metal matrix composite affecting mechanical properties, Large boron-containing particle size also tend to result in a lower neutron absorbing efficiency. Particle size is commonly limited to below 60 microns in the material use licenses and specifications. If the average particle size is smaller than 1 μm, then the fine powders may clump together, making it difficult to achieve an even mixture with the metal powder. For the purposes of the present invention, the average particle size shall refer to the D₅₀ value measured by laser diffraction particle size distribution measurement.

In one embodiment, the boron-containing powder has a multimodal distribution, wherein the average particle of the first mode (comprising the smaller particles) to the second mode (comprising the larger particles) is at least 1:2, 1:3, 1:5, 1:7, 1:11 or even 1:20. In one embodiment, the multimodal particle size distribution comprises at least two modes, a first mode of at least 1 micrometer and a second mode of at most 200 micrometers.

Method of Making

The composition of the present disclosure is made by first mixing the metal powder and the boron-containing powder to form a mixed powder. In one embodiment, the mixed powder comprises at least 0.1, 0.5, 1, 5, 10, 20 or even 30% and at most 40, 45, 50, 55, or even 60% by mass of the boron-containing powder. In the case of neutron shielding composition, the more boron-containing powder present, the better. However, as the content of the boron-containing powder increases, the deformation resistance for hot working increases, the workability becomes more difficult, and the formed article becomes more brittle. Additionally, the adhesion between the metal and boron-containing particles becomes poor, and gaps can occur, thus making more difficult the desired functions to be obtained and reducing the density, strength, and thermal conductivity of the resulting MMC. Furthermore, the cutting ability is also reduced as the boron-containing content increases.

The metal powder may be of one type alone, or may be a mixture of a plurality of types, and the boron-containing particles may likewise consist of one type alone or a plurality of ceramic types, such as by mixing in B₄C and Al₂O₃.

Typically the average particle size of the metal powder and the boron-containing powder will be selected for uniformity in the final material and maximum processing ease (e.g. increase compressibility). For example, if the metal and boron-containing powder have a similar density, it is preferable to match the metal powder particle size distribution with the boron-containing particle size distribution. This would allow the boron-containing powder particles to be more evenly distributed in the resulting MMC, having a property stabilizing effect. If the average particle size becomes too large, it becomes difficult to achieve an even mixture with boron-containing particles whose average particle size cannot be made too large due to a tendency to break, and if the average particle size becomes too small, the fine metal powder can clump together, making it difficult to obtain an even mixture with the boron-containing powder.

The powdered material is thoroughly mixed to insure substantially absolute uniformity. For this purpose, it is preferred to place the required amounts of powdered material in a power mixer and agitate until uniform distribution of one material throughout the other has been produced. The method of mixing as known in the art may be used, for example, using a mixer such as a cross-flow V-blender, a V blender or cross-rotary mixer, or a vibrating mill or planetary mill, for a designated time (e.g. 5 minutes to 10 hours). Additionally, media such as alumina balls or the like can be added for the purposes of crushing during mixture. Furthermore, mixing can be performed under dry or wet conditions. For example, to ease compaction or dust control a material, such as water, oil, solvents, dissolvents or other organic or inorganic compounds may be used.

Optionally, the mixed powder can be compacted to increase its density. Such compaction may include vibration, solid compaction, cold isostatic press, and cold uniaxial press. The compaction may occur by placing the loose powder within a vessel, such as a metal box and compacting the powder therein. The compacted powder may be further processing with the vessel (e.g., a metal box, which encases the composition) or the compacted powder may be removed from the vessel and either hot worked by itself or placed within metal to enclose the compacted powder during the hot working.

In one embodiment, the mixed powder is placed within a metal box (comprising a bottom and 4 sides). The metal box is placed within a die and the metal box is completely filled with the mixed powder. To insure that the powdered material is settled and to eliminate any substantial inclusion of air, the sides of the box may be struck with a mallet or hammer, or the filled container may be vigorously vibrated to accomplish the same purpose. A calculated amount of mixed powder is used such that upon compaction, ideally, the compacted mixed powder is level with the top surface of the metal box. Because the box is initially over-filled, in one embodiment, a riser frame (or sleeve) is placed over the metal box, which is located within a die, to contain the extra mixed powder having a first density. The mixed powder is compacted within the metal box with the use of solid compaction, cold isostatic press, or cold uniaxial press, which increases the density of the material, while allowing the powder to remain in a solid state. The particles are tightly packed preventing their displacement upon further handling and processing. However, no substantial melting of the metal powder occurs during the compaction step. After compacting the material a top forming plate is disposed on top of the metal box in solid abutment against the metal box and sealed around its edges and then hot worked. Such a process is described in U.S. Provisional Application No. 61/939,357 (3M Docket No. 75072US002 filed Feb. 13, 2014), herein incorporated by reference.

Although not wanting to be limited by theory it is believed that the compaction not only densifies the material, but also “sets” the particles preventing their movement or flow during subsequent handling and processing, resulting in a uniform metal matrix composite. Thus, in one embodiment, the pressure (or force) should be substantial enough to deform the metal powder and set the mixed powder, preventing the settling or movement of the particles upon handling and/or processing. Typically, the materials can become more dense as more pressure is applied. In some applications, the boron-containing particle can be crushed under the pressure of the compaction, which can diminish the resulting performance of the MMC.

The compaction of the mixed powder maximizes the amount of active material in a given part, improving the functionality of the resulting material. The compaction of the powders may also set the powders before hot working, forcing compaction and limiting deformation during the hot working step.

Hot Working

The mixed powder, typically compacted, is then subjected to hot working such as hot rolling, hot extrusion, hot forging, or hot vacuum pressing, thus further improving the powder mixed density while simultaneously approaching the desired shape. When preparing a plate-shaped clad material, it is possible to obtain a clad plate material having a designated clad ratio with a metal plate material. The hot working may consist of a single procedure, or may be a combination of a plurality of procedures. Additionally, cold working may be performed after hot working. In the case of cold working, the material can be made easier to work by annealing at 100-530° C. (preferably 400-520° C.) prior to working.

In the case of hot working, typically a compacted powder is first preheated to soften the metal before the hot working (e.g., hot rolling) step. The temperature used can vary depending on the composition of the mixed powder and the metal enclosure, if any. For example, when the mixed powder comprises more than 22% by weight of the boron-containing powder, the preheating should be such that the temperatures used should be at least 90%, 92%, 94% or even 96% of the melting temperature of the metal powder but not greater than the metal box melting point. In one embodiment, the metal (e.g., aluminum (AA1XXX series)) is heated to lower the resistance of the material, such temperature include: at least 400° C., 450° C., or even 500° C.; and at most 600° C., 620° C., or even 630° C.

In one embodiment, the compacted powder is stackloaded in a soaking furnace and preferably 1 inch spacers are provided between compacted powders to permit uniform heat-up from all sides. For example, when aluminum is used, the furnace temperature is held at 400° C., or preferably 500° C. or even as high as 600° C. but not higher than 660° C. and heated until the assembly is heated to the required hot working temperature.

If the compacted powder is clad by a metallic material, the surface will not have any boron-containing particles that might otherwise be a point of origin for damage during hot working or wear down the dies, the rolls or any other equipment touched by the material. As a result, it is possible to obtain a metal matrix composite material with good workability, excelling in strength and surface properties. Additionally the resulting material which has been subjected to hot working will have a surface clad with a metal, with good adhesion between the metal on the surface and the metal matrix material inside, thus having corrosion resistance, impact resistance and thermal conductivity superior to aluminum composite materials whose surfaces are not clad with a metallic material. The metal cladding used is not particularly limited as long as the metal excels in adhesion to the powder material and is suitable for hot rolling, such metals include: aluminum, magnesium, and stainless steel. Exemplary metals include, for example, pure aluminum (AA1100, AA1050, AA 1070, etc.); aluminum alloy materials such as Al—Cu alloy (AA2017 etc.), Al—Mg alloy (AA5052 etc.), Al—Mg—Si alloy (AA6061 etc.), Al—Zn—Mg alloy (AA7075 etc.) and Al—Mn alloy; magnesium alloy materials such as Mg—Al—Zn—Mn (AZ31, AZ61, etc); and stainless steel alloy material such as Fe—Cr (SAE 304, 316, 316L, etc).

It will be understood that the hot working operation reduces not only the thickness of the mixture of boron-containing powder and metal powder, but also reduces the thickness of the cladding which covers the finished material. The finishing clad to core ratio is dependent on the starting thickness ratio of the top and bottom metal plate on the compacted powder. The metal sheathing on opposite sides of the MMC core varies from 5 to 75% of final total thickness achieved. The MMC core of course being formed of the metallurgical bonded particles of ceramic powder and metal powder, and being permanently metallurgically bonded to the interior surfaces of the external sheathing.

While the precise dimensions can be varied as required, it is desirable to reduce the thickness of the pre-roll assembly, via the hot working step, to not more than ¼th to 1/60th of its original thickness, and to reduce the metal sheathing at opposite sides of the rolled material to a thickness not thinner than 0.002 inch (0.05 mm).

In one embodiment, following the hot working step, the MMC material is flattened. For this purpose it may be thermal flattened under weights or it may be flattened using a coil set remover, roller leveler or any similar process. In one embodiment, the thermal flattening in an oven is preferred. To accomplish this, the MMC material is placed in stacks under heavy weights in an oven at a temperature of about 400° C. If not all the material is flattened at the end of the cycle, those pieces which are flat are removed and the balance are returned for flattening. In some cases, the MMC material will be flat after rolling and will not undergo a flattening treatment.

In one embodiment, the MMC material with the metal cladding has a thickness of at least 1 mm, 1.5 mm, 2 mm, 5 mm, 10 mm, 15 mm, or even 20 mm; and at most 50 mm, 100 mm, or even 200 mm.

A guillotine shear, water jet cutting, laser cutting, plasma cutting or any other metal cutting process may be used to cut the MMC material to the required size for use.

In one embodiment, the MMC is removed from the metal cladding after material fabrication.

### EXAMPLES

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight (wt) unless otherwise indicated.

Materials

| Material | Source |
|---|---|
| Al A | aluminum, atomized, Spherical D₅₀ = 15.3 microns, normal |
| | distribution, Aluminium Powder Company, Ltd., United |
| | Kingdom. |
| Al B | aluminum, atomized, Spherical, D₅₀ = 29.2 microns, normal |
| | distribution, Aluminium Powder Company, Ltd., United |
| | Kingdom |
| BC A | boron carbide, jet milled, D₅₀ = 12 microns, UK Abrasives, |
| | Chicago (IL), USA |
| BC B | boron carbide, jet milled, D₅₀ = 22.8 microns, UK Abrasives, |
| | Chicago (IL), USA |
| BC C | boron carbide, jet milled, D₅₀ = 12.8 microns, UK Abrasives, |
| | Chicago (IL), USA |
| BC D | boron carbide, ball milled, D₅₀ = 39.0 microns, ESK |
| | Ceramics, Kempten, Germany |
| BC E | boron carbide, ball milled, D₅₀ = 83 microns, sieved to |
| | D₅₀ ± 8 microns to narrow distribution. |
| BC F | boron carbide, jet milled, D₅₀ = 36.5 microns, UK Abrasives, |
| | Chicago (IL), USA |
| BC G | boron carbide, ball milled, D₅₀ = 17.9 microns, ESK |
| | Ceramics, Kempten, Germany |
| BC H | boron carbide, jet milled, D₅₀ = 29.2 microns, UK Abrasives, |
| | Chicago (IL), USA |
| BC I | boron carbide, ball milled, D₅₀ = 11 microns, ESK Ceramics, |
| | Kempten, Germany |
| Top and | hot rolled AA1100 (commercial pure) aluminum (0.250 |
| bottom | inches thick (6 mm)), O-temper, Zhengzhou Mingtai Industry |
| plates | Co., Zhengzhou Henan, China |
| Side plates | hot rolled AA1100 (commercial pure) aluminum (0.500 |
| | inches thick (12 mm)), O-temper, Alcoa Inc. Battendorf, IA |

Tap Density

Various amounts of boron-containing powder and aluminum powder were blended together using a laboratory scale 1 quart V-blender. All powders were put in the blender per mix recipe before blending. The mixed powder was then transferred to storage containers and the tap density was measured applying ASTM standard B527-06 (3000 tap in a 100 ml cylinder). Shown in Table 1 below is type and amount of the various powders used and their tap density.

TABLE 1

| | | | | | Tap density |
|---|---|---|---|---|---|
| Sample | Amount and Type BC | | Amount and Type Al | | (g/cm³) |
| CE 1 | 100% A | | 100% A | | 1.493 |
| CE 2 | 100% D | | 100% B | | 1.538 |
| CE 3 | 100% F | | 100% B | | 1.640 |
| 1 | 90% A | 10% E | 100% A | | 1.538 |
| 2 | 90% A | 10% E | 100% B | | 1.613 |
| 3 | 90% A | 10% E | 71% B | 29% A | 1.587 |
| 4 | 90% A | 10% E | 71% B | 29% A | 1.563 |
| 5 | 90% A | 10% E | 71% B | 29% A | 1.538 |
| 6 | 19% A | 81% D | 81% B | 19% A | 1.639 |
| 7 | 29% A | 71% D | 71% B | 29% A | 1.695 |
| 8 | 39% A | 61% D | 61% B | 39% A | 1.667 |
| 9 | 90% B | 10% E | 100% B | | 1.613 |
| 10 | 90% B | 10% E | 71% B | 29% A | 1.587 |
| 11 | 29% G | 71% B | 71% B | 29% A | 1.613 |
| 12 | 29% G | 71% D | 71% B | 29% A | 1.639 |
| 13 | 30% C | 70% H | 70% B | 30% A | 1.613 |

As shown in Table 1 above, using a biomodal distribution of boron-containing particles appears to have improved packing efficiency, observed by an increase in the tap density of the mixed powder. The tap density increases when large aluminum particles are used as shown in Examples 1 and 2. However larger aluminum particles may cause heterogeneity in the boron-containing powder distribution. Therefore, using a multimodal distribution for the metal particles may be advantageous to maximize the tap density, but minimize the presence of air gaps. This same phenonenom is observed for the boron-containing particles as well. See examples 2 and 9. For the particle size used there may be an optimum value. For example, Examples 6-8 used the same powders but varying amounts, Example 7 had a higher tap density than either Examples 6 or 8.

Cold Pressing

Sample 7 and 8 from Table 1 were cold pressed in a powder testing center (National Research Council, Boucherville, Canada) that accurately measures powder density as a function of the applied force. A known and constant mass of powder to be characterized was poured in a cylindrical die cavity having a precisely measured diameter. Force is applied to a top punch, which is accurately measured, as well as the displacement of the punch. The real-time density is measured by dividing the constant mass of powder by the volume of the die cavity. The measurement was done on a 1 cubic centimeter powder sample. Sample was not vibrated before pressing. The die is made of polished tool steel. The results are shown in Table 2 below.

TABLE 2

Density (g/cm³) after

| | Cold press | Cold press |
|---|---|---|
| Sample | density at 10 TSI | density at 15 TSI |
| 7 | 2.048 | 2.189 |
| 8 | 2.043 | 2.191 |

Hot Rolled

A aluminum metal box (outside dimensions of 7 inches (178 mm) in width×11 inches (279 mm) in length×2 inches (50.8 mm) high) was constructed by metal inert gas (MIG) welding 4 side plates and a bottom plate. The base material is chamfered 45°, % inch (9.5 mm) deep to optimize weld resistance. The weld is done using 1/16 inch (1.6 mm) AA1100 welding wire. Sides of the box were 0.5 in (12.7 mm) thick, while the bottom and top plate of the box was 0.25 in (6.4 mm) thick.

The powders, described in Table 3 below, were blended for 10 minutes in a Patterson-Kelley crossflow V-blender (Buflovak LLC, Buffalo, N.Y.) under a nitrogen atmosphere. A calculated amount of the mixed powder was placed in the metal box to yield a filled box after compaction. Note: when doing compaction, the loose mixed powder overfills the metal box, therefore a sleeve is placed around the metal box to contain loose powder. The metal box is placed in a 7 in×11 in steel die, a 6 in×10 in steel punch was placed on top. The mixed powder was then compacted at 7 TSI (tons per square inch) pressure using a 470T capacity compacting press (Accudyne Engineering & Equipment Co., Bell Gardens, Calif.). Then, the sleeve was removed and a Top plate was placed on top of the box and MIG welded with AA1100 filler wire to make a pre-roll assembly. Three vent holes (4×¼ in diameter holes) were drilled into each end on two opposing sides of the metal box. The assembly was heated for 16 hours at 600° C.±10° C. in a convection furnace. The heated assembly was then rolled using a 2-high Fenn reversing rolling mill (800 tons separating force). The pre-roll assembly was passed 13 times at a 22% reduction reducing the thickness from 2.5 inches (63.5 mm) to 0.100 inch (2.5 mm). Rolling coolant is applied on the 30 inch diameter steel rolls between each pass. Two cross-rolls (widthwise rolling) are done at passes 3 and 4. The assembly was rolled to 0.100 in (2.5 mm) thick and the resulting articles are allowed to cool to room temperature.

The results are shown in Table 3 below. The final density is measured per ASTM B311-08 on a sheared cut portion of the plate. The density samples are 1 in×1 in×0.100 in (2.5 cm×2.5 cm×0.25 cm).

TABLE 3

| | Amount and type | | Density |
|---|---|---|---|
| Sample | BC | Amount and type Al | (g/cm³) |
| CE 4 | 100% I | 100% A | 2.598 |
| CE 5 | 100% D | 100% B | 2.602 |
| 14 | 29% I, 71% D | 71% B, 29% A | 2.604 |

Foreseeable modifications and alterations of this invention will be apparent to those skilled in the art without departing from the scope and spirit of this invention. This invention should not be restricted to the embodiments that are set forth in this application for illustrative purposes.

1. A radiation shielding composition comprising:
(i) a boron-containing powder wherein the boron-containing powder comprises at least a bimodal particle size distribution, and
(ii) a metal, wherein the metal encapsulates the ceramic powder to form the radiation shielding composition.

2. The radiation shielding composition of claim 1, wherein the radiation shielding composition comprises at least 5% by mass of boron-containing powder.

3. The radiation shielding composition of claim 1, wherein the at least bimodal particle size distribution comprises at least one D₅₀ of at least 10 micrometers.

4. The radiation shielding composition of claim 1, wherein the at least bimodal particle size distribution comprises modes of at least 1 micrometer and at most 200 micrometer.

5. The radiation shielding composition of claim 1, wherein the boron-containing powder is selected from boron carbide.

6. The radiation shielding composition of claim 1, wherein the metal is selected from at least one of aluminum, magnesium, and stainless steel and combinations thereof.

7. A method for making a radiation shielding composition comprising:
(a) providing (i) a boron-containing powder wherein the boron-containing powder comprises at least a bimodal particle size distribution, and (ii) a metal powder;
(b) mixing the metal powder and the boron-containing powder to prepare a mixed powder; and
(c) performing hot working on the mixed powder to obtain the radiation shielding composition.

8. The method of claim 7, wherein the radiation shielding composition comprises at least 5% by mass of the boron-containing powder.

9. The method of claim 7, wherein the at least bimodal particle size distribution comprises at least one D₅₀ of at least 30 micrometers.

10. The method of claim 7, wherein the at least bimodal particle size distribution comprises modes of at least 1 micrometer and at most 200 micrometer.

11. The method of claim 7, wherein the boron-containing powder is selected from boron carbide.

12. The method of claim 7, wherein the metal powder is selected from at least one of aluminum, magnesium, and stainless steel and combinations thereof.

13. The method of claim 7, wherein the metal powder comprises at least a bimodal particle size distribution.

14. The method of claim 13, wherein the at least a bimodal particle size distribution of the metal powder comprises at least one D₅₀ of at least 30 micrometers.

15. The method of claim 7, further comprising compacting the mixed powder.

16. The method of claim 15, wherein the compacting is preformed using at least one of: vibration, solid compaction, cold isostatic press, and cold uniaxial press.

17. The method of claim 7, wherein the metal box is selected from at least one of aluminum, magnesium, and stainless steel.

18. The method of claim 7, wherein the mixed powder is pre-heated prior to the hot working.

19. The method of claim 7, wherein the hot working is selected from at least one of hot rolling, hot extrusion, and hot forging.

20. A method of making a radiation shielding composition comprising:
(a) providing (i) a boron-containing powder wherein the boron-containing powder comprises at least a bimodal particle size distribution, and (ii) a metal powder;
(b) mixing the metal powder and the boron-containing powder to prepare a mixed powder;
(c) filling a metal container with the mixed powder;
(d) disposing a top forming plate onto the metal container in solid abutment against the metal container comprising the powder and sealing around its edges to produce a pre-rolling assembly; and
(e) performing hot working on the pre-rolling assembly to obtain the radiation shielding composition with a metal cladding.
